(19) United States
(12) Patent Application Publication
(10) Pub. No.: US 2026/0036548 A1
(43) Pub. Date: Feb. 5, 2026

(54) MEASUREMENT DEVICE AND MEASUREMENT METHOD

(71) Applicant: JAPAN SCIENCE AND TECHNOLOGY AGENCY, Saitama (JP)

(72) Inventors: Kenji IKUSHIMA, Tokyo (JP); Nobuto KAITOH, Tokyo (JP)

(21) Appl. No.: 19/352,652

(22) Filed: Oct. 8, 2025

Related U.S. Application Data
(63) Continuation of application No. PCT/JP2024/013023, filed on Mar. 29, 2024.

(30) Foreign Application Priority Data
Apr. 13, 2023 (JP) 2023-065838

(51) Int. Cl. G01N 27/60

(52) U.S. Cl. CPC G01N 27/60

(57) ABSTRACT

A measurement device comprises a sound wave source that irradiates sound waves to different points in the measurement object; and a measurement unit that receives an electromagnetic field generated at each point of the measurement object to which the sound waves are irradiated, and measures a signal indicating at least one characteristic selected from the group comprising electrical characteristics, magnetic characteristics, electromechanical characteristics and magnetomechanical characteristics of the measurement object based on at least one selected from the group comprising the intensity, phase and frequency of the received electromagnetic field. The sound waves generated by the sound wave source reach at different points in the measurement object simultaneously.

### BACKGROUND OF THE INVENTION

### 1. Field of the Invention

This disclosure relates to a measurement device and a measurement method.

### 2. Description of the Related Art

The measurement technique “Acoustically Stimulated EM Method”, hereinafter referred to as “ASEM method” (Acoustically Stimulated EM method)), developed by the inventors, modulates the electric charge and magnetization of a measurement object by irradiating it with sound waves. The principle and features of ASEM are outlined below.

### PRIOR ART LITERATURE

### Patent Literature

Patent Literature 1: International Publication No. WO2007/055057

While the ASEM method has the advantage of non-destructive and high-resolution measurement of measurement objects irradiated with sound waves, it has the limitation that the ASEM signal obtained without modification is weak. In other words, the ASEM method has the problem of increasing the ASEM signal obtained from the measurement object irradiated with sound waves as much as possible. In this case, the larger the area irradiated by sound waves, the larger the ASEM signal obtained, which is considered advantageous. To achieve this, it is conceivable, for example, to use multiple sound wave generators to irradiate electric waves to different points in a large area of the measurement object. In contrast, for example, in conventional ultrasonic echo, the sound waves are focused and irradiated to a relatively narrow area of the measurement object because it is necessary to prevent a reduction in spatial resolution. In this case, there is no advantage in increasing the irradiation area of the sound waves. On the other hand, the images obtained by the ASEM method are not for evaluating tissue structure, therefore appropriately increasing the irradiation area does not pose a practical problem.

Note that even in the ASEM method, merely irradiating sound waves to different points in the measurement object with multiple sound wave generators does not produce a sufficiently strong ASEM signal. This is because even if multiple sound wave generators are used to irradiate sound waves to different points in the measurement object, the sound waves irradiated to each point will not be in phase. For example, an ordinary single-point focused ultrasonic transducer consists of a spherical shape to narrow the focus, and its spot size is fixed. Even if the focus point is shifted to increase the irradiation area, the signals are not in phase. Therefore, the ASEM signal will not be increased when the transducer is applied to the ASEM method as it is. The array probe type transducer also scans the beam by creating a spherical waveform by timing the pulses applied to each microtremor to form a waveform. Also in this case, sound waves irradiated to each point of the object are not in phase.

### SUMMARY OF INVENTION

The present disclosure was made in view of the above problems and a general purpose thereof is to obtain a larger ASEM signal in a measurement using the ASEM method by aligning the phases of sound waves irradiated to each point in the area while irradiating sound waves over a wide area of the measurement object.

To solve the above problem, one embodiment of the present disclosure relates to a measurement device for non-invasively measuring a measurement object. The device comprises a sound wave source that irradiates sound waves to different points in the measurement object; and a measurement unit that receives an electromagnetic field generated at each point of the measurement object to which the sound waves are irradiated, and measures a signal indicating at least one characteristic selected from the group comprising electrical characteristics, magnetic characteristics, electromechanical characteristics and magnetomechanical characteristics of the measurement object based on at least one selected from the group comprising the intensity, phase and frequency of the received electromagnetic field. The sound waves generated by the sound wave source reach at different points in the measurement object simultaneously.

In one embodiment, the sound wave source may include a plurality of sound wave generators. Each of the plurality of sound wave generators irradiates sound waves to different points in the measurement object. The sound waves generated by the plurality of sound wave generators reach at different points in the measurement object simultaneously.

In one embodiment, the measurement device may further comprise a control unit that controls the timing of the sound wave generation of each of the plurality of sound wave generators so that the generated sound waves reach different points in the measurement object at the same time.

In one embodiment, the sound wave source may be a one-dimensional array probe in which the plurality of sound wave generators are arranged in a substantially linear array.

In one embodiment, the control unit may control so that the drive time of the sound wave generator at the shortest distance among the distances between each point of the measurement object irradiated with sound waves by the plurality of sound wave generators and each sound wave generator and the measurement start time of the measurement unit are equal.

In one embodiment, the measurement device may further comprise an imaging unit that images the signal measured by the measurement unit.

In one embodiment, the measurement device may further comprise an echo receiver that receives echo signals from the points where each of the plurality of sound wave generators irradiates sound waves. The control unit controls so that so that the drive time of the sound wave generator at the shortest distance among the distances between each point of the measurement object irradiated with sound waves by the plurality of sound wave generators and each sound wave generator, the measurement start time of the measurement unit and the echo reception start time of the echo receiver are equal. The imaging unit images both the signal measured by the measurement unit and the echo signal.

In one embodiment, the measurement device may comprise a plurality of group of the sound wave generators including a subset of sound wave generators selected from the plurality of sound wave generators. Each of the plurality of group of sound wave generators measures a different area of the measurement object, each scanning over the surface of the measurement object.

In one embodiment, each of the plurality of sound wave generators may measure a different area of the measurement object at different times, each scanning over the surface of the measurement object.

In one embodiment, each of the plurality of sound wave generators may generate sound waves once for each of the different points within the area of the measurement object with staggered timings. The control unit controls the timing of sound wave generation for each of the plurality of sound wave generators so that the sound waves generated at all generation timings reach the different points at the same time.

In one embodiment, the sound waves generated by the plurality of sound wave generators may be continuous pulses.

In one embodiment, the sound wave source may be a two-dimensional array probe in which the plurality of sound wave generators are arranged in a substantially plane array.

In one embodiment, the two-dimensional array probe may be an annular array probe in which a plurality of annular type elements are concentrically arranged. The control unit controls the timing of sound wave irradiation of each of the plurality of sound wave generators so that the sound waves generated by each of the annular elements reach different points in the measured object at the same time.

Another embodiment of the present disclosure is a measurement method. This method is a method for non-invasively measuring a measurement object. This method comprises generating sound waves using sound wave generating means to irradiate different points in a measurement object; receiving an electromagnetic field generated at each point where the sound waves are irradiated; and measuring a signal indicating at least one characteristic selected from the group comprising electrical characteristics, magnetic characteristics, electromechanical characteristics and magnetomechanical characteristics of the measurement object based on at least one selected from the group comprising the intensity, phase and frequency of the received electromagnetic field. Sound waves generated by the sound wave generating means reach different points in the measurement object at the same time.

Any combination of the above components, and any conversion of the expressions of the present disclosure among devices, methods, systems, recording media, computer programs, etc., is also valid as an aspect of the present disclosure.

### BRIEF DESCRIPTION OF DRAWINGS

FIG. 1 is a schematic diagram showing the electric and magnetic fields stimulated by the irradiation of sound waves to a measurement object;

FIG. 2 is a functional block diagram of a measurement device according to the first embodiment;

FIG. 3 is a schematic diagram of a sound wave source according to the first embodiment;

FIG. 4 is a schematic diagram of a sound wave source according to a comparison example;

FIG. 5 is a schematic diagram of a sound wave source according to another comparison example;

FIG. 6 is a functional block diagram of a measurement device according to the second embodiment;

FIG. 7 is a schematic diagram of a sound wave source according to the second embodiment;

FIG. 8 is a schematic diagram of a sound wave source according to the second embodiment;

FIG. 9 is a functional block diagram of a measurement device according to the third embodiment;

FIG. 10 is a functional block diagram of a measurement device according to the fourth embodiment;

FIG. 11 is a schematic diagram of a sound wave source according to the fifth embodiment;

FIG. 12 is a schematic diagram of a sound wave source according to the sixth embodiment;

FIG. 13 is a schematic diagram of a sound wave source according to the seventh embodiment;

FIG. 14 is a schematic diagram showing a vibration profile of a spherical wave according to the seventh embodiment;

FIG. 15 is a schematic diagram of a sound wave source according to the eighth embodiment;

FIG. 16 is a schematic diagram showing a vibration profile of a spherical wave according to the eighth embodiment;

FIG. 17 is a schematic diagram of a one-dimensional array probe according to the ninth embodiment;

FIG. 18 is a schematic diagram of a two-dimensional array probe according to the tenth embodiment;

FIG. 19 is a schematic diagram of an annular array probe according to the eleventh embodiment;

FIG. 20 is a flowchart of the measurement method according to the twelfth embodiment;

FIG. 21 is a photograph showing the setup for Experiment 1;

FIG. 22 is a graph showing the relationship between the x-directional position of the hydrophone and the sound pressure in Experiment 1;

FIG. 23 is a photograph showing the half-value area against the irradiated surface width in Experiment 1;

FIG. 24 is a schematic diagram showing the setup for Experiment 2;

FIG. 25 is a graph showing the relationship between the square root of the irradiated area and the amplitude of the ASEM signal in Experiment 2;

FIG. 26 is a graph showing the relationship between the focal distance and the maximum sound pressure obtained in Experiment 3;

FIG. 27 is a schematic diagram showing the radius and ulna in cross section of a human arm;

FIG. 28 is a superimposed photograph of the images obtained from an ASEM and an echo signal;

FIG. 29 shows the time variation of an ASEM signal; and

FIG. 30 shows the time variation of an echo signal.

### DETAILED DESCRIPTION OF THE INVENTION

The disclosure will now be described by reference to the preferred embodiments. This does not intend to limit the scope of the present invention, but to exemplify the disclosure.

The disclosure will now be described with reference to the drawings based on suitable embodiments. In the embodiments and variations, identical or equivalent components, steps, and members shall be marked with the same symbols, and redundant explanations will be omitted where appropriate. The dimensions of the components in each drawing are shown enlarged or reduced as appropriate for ease of understanding. In each drawing, some parts and signs that are not important in explaining the embodiment are omitted. In addition, terms including ordinal numbers such as first and second are used to describe various components, but these terms are used only to distinguish one component from other components, and the components are not limited by these terms.

Acoustically Stimulated Electromagnetic Method (ASEM method)

Before describing the specific embodiment, an overview of the Acoustically Stimulated Electromagnetic method (ASEM method) is explained as a basic knowledge.

Ultrasonic measurements, e.g., ultrasonic echo method, as a conventional technique have been widely used for non-destructive testing on the human body and structures. One of its important advantages is that ultrasonic waves have high internal permeability to objects such as living bodies, metals and concrete blocks, which are difficult for light to penetrate. Furthermore, due to the significant difference between the speed of sound and the speed of light, sound waves have a wavelength that is approximately five orders shorter than that of electromagnetic waves at the same frequency. This means that in the MHz and GHz frequency bands, where waveforms can be easily acquired in real time, it is possible to focus on the order of millimeters and micrometers, i.e., spatial resolution. Despite these advantages, however, most ultrasonic measurements are limited in their use to inspect the mass density distribution and elastic properties of objects. This means that conventional ultrasonic measurements detect “scratches and foreign objects” but do not probe “electricity or magnetism.”

Sound waves, being elastic waves, are characterized by the fact that they are not directly coupled to electrical and magnetic properties as electromagnetic waves are. However, elastic modulation can often modulate the charge or magnetic moment of an object in time, through lattice distortion of solids or density changes in liquids. This means that when an object is irradiated with ultrasonic waves, electromagnetic waves of the same frequency as the ultrasonic waves, usually RF waves—microwaves, can be generated through dipole radiation. Thus, electromagnetic waves excited by sound waves such as ultrasound are called “Acoustic Stimulated Electromagnetic waves” or “ASEM waves.”

By irradiating an object with a converging beam of sound waves, the local ion concentration of the object and the associated flux density gradient of the medium can be temporally and spatially modulated to stimulate electromagnetic radiation. The Acoustic Stimulated Electromagnetic method (ASEM method) is a new method of measuring objects based on this principle. In other words, the ASEM method modulates the charge and magnetization of a measurement object by irradiating it with sound waves, causing information on its electrical and magnetic properties to be transmitted externally in the form of acoustic stimulated electromagnetic waves. As mentioned above, sound waves can provide about five orders higher spatial resolution at the same frequency than electromagnetic waves. For example, the wavelength of a 10 MHz electronic wave is 30 m, whereas the wavelength of an underwater sound wave is 150 μm. Therefore, the scanning of the sound wave convergence beam makes it possible to image the object with high resolution.

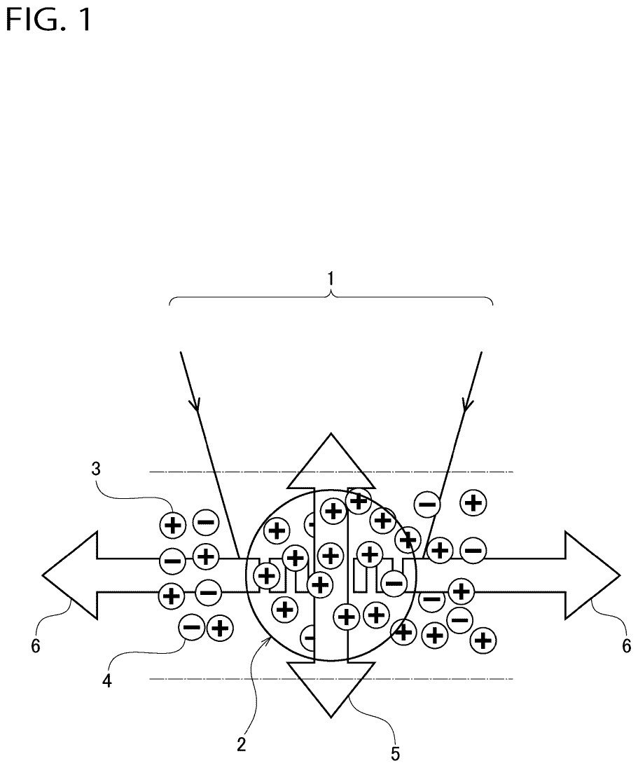

FIG. 1 is a schematic diagram of the electric and magnetic fields stimulated by sound waves on a measurement object. In FIG. 1, the sound wave focused beam 1 is shown focused on the part 2 to be measured. The circled + and − symbols indicate positive charged particles 3 and negative charged particles 4, respectively. In the sound wave focusing area 2, the concentration of positively charged particles 3 and negatively charged particles 4 is out of balance and the charge distribution state, in which positively charged particles 3 outnumber negatively charged particles 4, is shown. On the other hand, in the area outside the sound wave focusing area 2, the concentrations of positively charged particles 3 and negatively charged particles 4 are balanced. Arrow 5 indicates the direction of sonic vibration of the sonic focusing beam 1, which corresponds to the direction of the electric field.

As shown in FIG. 1, the positively charged particles 3 and negatively charged particles 4 vibrate at the same frequency as the sound wave in the direction of the sound wave vibration, which is indicated by arrow 5, due to the irradiation of the sound wave focused beam 1. The vibration of the positively charged particles 3 and negatively charged particles 4 stimulates an electric field parallel to the vibration direction 5 and a magnetic field, which is indicated by arrow 6, generated in the plane perpendicular to the vibration direction 5. Since the electric or magnetic fields generated by the same vibration of the positive charged particle 3 and the negative charged particle 4 are π out of phase with each other, they cancel each other out. Therefore, no net electric field or magnetic field is stimulated in the area outside the sound wave focusing area 2. On the other hand, in the sound wave focusing area 2, there are more positively charged particles 3 than negatively charged particles 4, therefore the electric or magnetic fields do not completely cancel each other out and a net electric or magnetic field is stimulated. Therefore, if the electric or magnetic field stimulated by the sound wave is measured and a change in the intensity of the electric or magnetic field is observed, it indicates that a change in the charge distribution, i.e., a change in the concentration of either positively charged particles 3 or negatively charged particles 4, or both, has occurred. Thus, from the measurement of the electric or magnetic field stimulated by sound waves, it is possible to measure the characteristic value of the charged particles in the measurement object, in this case, the change in their concentration.

Hereafter, the electric and magnetic fields are collectively referred to as the “electromagnetic field.” FIG. 1 shows an example of measuring the change in concentration of charged particles from the measurement of the electromagnetic field stimulated by sound waves. However, changes in the characteristic values of charged particles that can be measured are not limited to concentration, but also include changes in mass, size, shape, number of charges or interaction force with the medium surrounding the charged particles. For example, if it is known from other knowledge about the state of the measurement object being that changes in concentration, mass, size, shape and charge number are unlikely to occur, then changes in the intensity of the measured electromagnetic field can be linked to changes in the interaction force with the medium surrounding the charged particles. Thus, for example, the measured change in the intensity of the electromagnetic field can be linked to a change in the electron polarization rate or the positive ion polarization rate.

In particular, a signal indicating at least one characteristic selected from the group comprising electrical characteristics, magnetic characteristics, electromechanical characteristics and magnetomechanical characteristics of the measurement object can be extracted based on at least one selected from the group comprising the intensity, phase and frequency of the received electromagnetic waves by irradiating sound waves at the measurement object and receiving electromagnetic waves generated at this measurement object. In this case, changes in at least one characteristic value selected from the group comprising the electric field, dielectric constant, spatial gradient of the electric field or dielectric constant, concentration, mass, size, shape, number of charges and interaction of the charged particles with the medium surrounding the charged particles in the measurement object can be measured as electrical properties of the measurement object. In addition, magnetization due to the electron spin or nuclear spin of the measurement object, and acoustic magnetic resonance due to the electron spin or nuclear spin of the measurement object can also be measured as magnetic properties of the measurement object. Furthermore, the piezoelectric or magnetostrictive properties of the object can be measured as electromechanical and magnetomechanical properties of the measurement object. Thus, the ASEM method can measure electrical, magnetic, electromechanical and magnetomechanical properties of the measurement object inside the object in a nondestructive and high-resolution manner.

### ASEM Signal Intensity

The inventors have studied the intensity of the ASEM signal and have made the following findings. First, the amplitude V_{sig} of the ASEM signal is proportional to the volume integral of the electric dipole moment p (r) in the area to be irradiated by sound waves. For example, if we assume a constant depth value 1, e.g., about half the wavelength of the sound wave, in the area to be irradiated, V_{sig} can be approximated as follows.

$${V}_{s i g} ∝ {\int }_{{V}_{i r r}} p ( r ) d V \approx \overline{p} {V}_{i r r} = \overline{p} {S}_{i r r} l \qquad [ Equation 1 ]$$

### Here,:

$$\overline{p} \qquad [ Equation 2 ]$$

is the average value of the electric dipole moment in the irradiated area, Vᵢᵣᵣ is the volume of the irradiated area and Sᵢᵣᵣ is the surface area of the irradiated area, i.e., the area of the irradiated surface. In other words, the ASEM signal amplitude, or ASEM signal voltage, is proportional to the irradiated area.

$${V}_{s i g} ∝ \overline{p} {S}_{i r r} \qquad [ Equation 3 ]$$

For piezoelectric polarization,:

$$\overline{p} \qquad [ Equation 2 ]$$

is proportional to the sound pressure Tᵢᵣᵣ of the irradiated sound wave, and its proportionality coefficient is the piezoelectric coefficient d. In this case,:

$${T}_{irr} ∝ \sqrt{u \frac{S}{{S}_{i r r}}} = \sqrt{u} \frac{R}{{R}_{i r r}} \qquad [ Equation 4 ]$$

holds, therefore:

$${V}_{s i g} ∝ d {T}_{irr} {S}_{i r r} ∝ \sqrt{u} \sqrt{S {S}_{irr}} ∝ \sqrt{S {S}_{irr}} \qquad [ Equation 5 ]$$

is obtained. where S is the surface area of the sound wave source, e.g., the area of the transducer surface, and u is the radiating surface density at the sound wave source. From this, it can be seen that the ASEM signal voltage is proportional to the square root of the product of the transducer surface and the irradiated surface. Therefore, if the same transducer, of which area is S, is used, the larger the irradiated area, the larger the ASEM signal. In other words, the ASEM signal voltage obtained is larger when the irradiated sound wave is not focused.

In contrast, in the case of echo signals in the conventional ultrasonic echo method, if the same transducer, of which area is S, is used, it is known that if the irradiated sound wave is sufficiently focused, the spatial resolution can be increased and the echo signal obtained is also larger. In other words, in conventional imaging such as echo diagnosis, there was no merit in increasing the spot size, i.e., irradiated area, at the focus point of the sound wave. Therefore, the conditions for increasing the size of the obtained signal are completely different between the conventional ultrasonic echo method and the ASEM method.

However, in the ASEM method, for:

$$\overline{p} ∝ {T}_{i r r} \qquad [ Equation 6 ]$$

to hold, the sound pressure must be applied in the same phase at all irradiated surfaces. This is because if the sound waves are not in phase at all irradiated surfaces, the signals will cancel each other out and the obtained signal will be weakened. From the above, it is clear that the key to obtaining a larger ASEM signal in measurements using the ASEM method is to irradiate sound waves over a wide area of the measurement object and to make the sound waves irradiated at each point in the area in phase.

### The First Embodiment

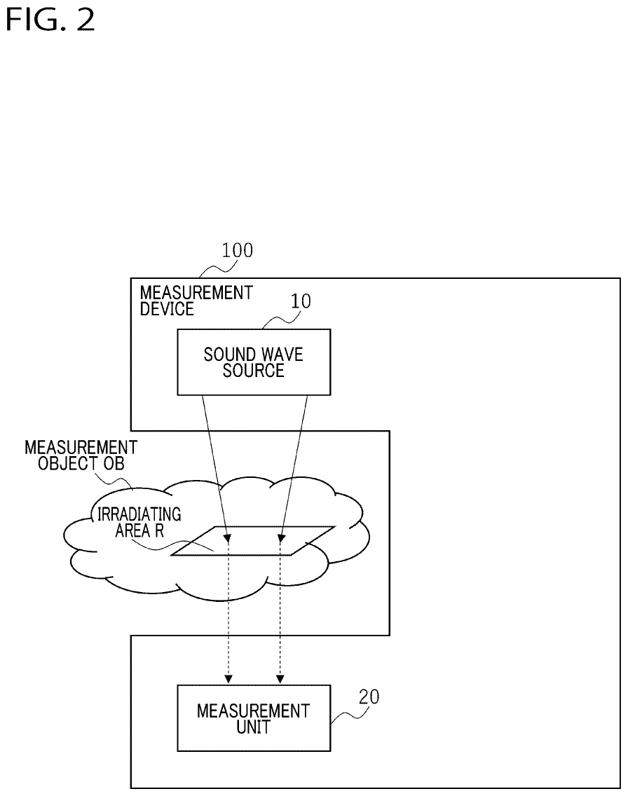

FIG. 2 is a functional block diagram of a measurement device 100 according to the first embodiment. The measurement device 100 measures a measurement object OB non-invasively. The measurement device 100 comprises a sound wave source 10 and a measurement unit 20.

The sound wave source 10 generates sound waves, such as ultrasonic waves, and irradiates the sound waves to different points in a predetermined area of the measurement object OB, respectively.

The measurement unit 20 receives the electromagnetic field generated at each point of the measurement object OB to which the sound waves are irradiated, and measures a signal indicating at least one characteristic selected from the group comprising electrical characteristics, magnetic characteristics, electromechanical characteristics and magnetomechanical characteristics of the measurement object OB based on at least one selected from the group comprising the intensity, phase and frequency of the received electromagnetic field. The signal indicating at least one characteristic selected from the group comprising electrical characteristics, magnetic characteristics, electromechanical characteristics and magnetomechanical characteristics of the OB being measured is measured.

The sound waves generated by the sound wave source 10 reach different points in the measurement object OB simultaneously.

For example, signals indicating magnetization caused by electron spin or nuclear spin, which are magnetic properties of the measurement object OB, can be measured as follows. As in the case of electric polarization, electromagnetic fields are also generated by time variation of magnetization. According to Maxwell's equation, the radiated electric field is proportional to the second-order time derivative of magnetization. Therefore, it is possible to measure signals indicating the magnitude and direction of magnetization from the electromagnetic field intensity and phase.

Also, for example, signals indicating acoustic magnetic resonance caused by electron and nuclear spins, which are magnetic properties of the measurement object OB, can be measured as follows. Since sound waves are efficiently absorbed at a certain resonance frequency and the direction of electron and nuclear spins changes, it is expected that the electromagnetic field intensity and phase will change significantly at that frequency. Therefore, the resonance frequency can be determined as information. In addition, as in ordinary ESR, i.e., electron spin resonance, or in NMR, i.e., nuclear magnetic resonance, a spectrum can be obtained by scanning the frequency of the sound wave, and signals indicating electron and nuclear spins can be measured. It is also possible to measure signals indicating the relaxation time of electron spin and nuclear spin.

Also, for example, signals indicating piezoelectric or magnetostrictive properties, which are electromechanical or magnetomechanical properties of the measurement object OB, can be measured as follows. In ionic crystals without inversion symmetry, electrical polarization is, in principle, caused by strain. Therefore, a signal indicating the magnitude of the polarization can be measured from the intensity of the electromagnetic field of the measurement object OB, which can be said to be an acoustically stimulated electromagnetic wave. By scanning the sound waves, the piezoelectric properties of the measurement object OB can be imaged. Furthermore, from the direction of sound wave propagation and the angular distribution of the electromagnetic field generated, a signal indicating the piezoelectric tensor can be measured in a non-contact manner without the need for electrodes on the measurement object OB.

Furthermore, for example, signals indicating magnetostrictive properties, which are electromechanical or magnetomechanical properties of the measurement object OB, can be measured as follows. Magnetostriction is a phenomenon in which the electron orbitals are changed due to crystal distortion and a change is applied to the electron spin magnetization through orbital-spin interactions. In other cases, the magnetic domain structure is changed by external strain, resulting in a change in the effective magnetization in a macroscopic area, of which size is about that of a sonic beam spot. Crystal distortion can also cause changes in crystal field splitting, which can alter the electronic state and change the magnitude of the electron spin magnetization. These temporal changes are thought to generate electromagnetic fields. Therefore, the magnitude of magnetization, orbital-spin interaction, sensitivity to crystal distortion and electron orbital change, sensitivity to crystal field splitting and distortion, relationship between crystal field splitting and electron spin state, or relationship between magnetic domain structure and distortion can be determined from the intensity of acoustic stimulated electromagnetic waves. From the direction of sound wave propagation and radiation intensity, signals indicating the magnetostriction tensor can be measured in a non-contact manner without the need for electrodes on the measurement object OB. Imaging of the magnetostrictive properties is also possible, as well as the piezoelectric properties.

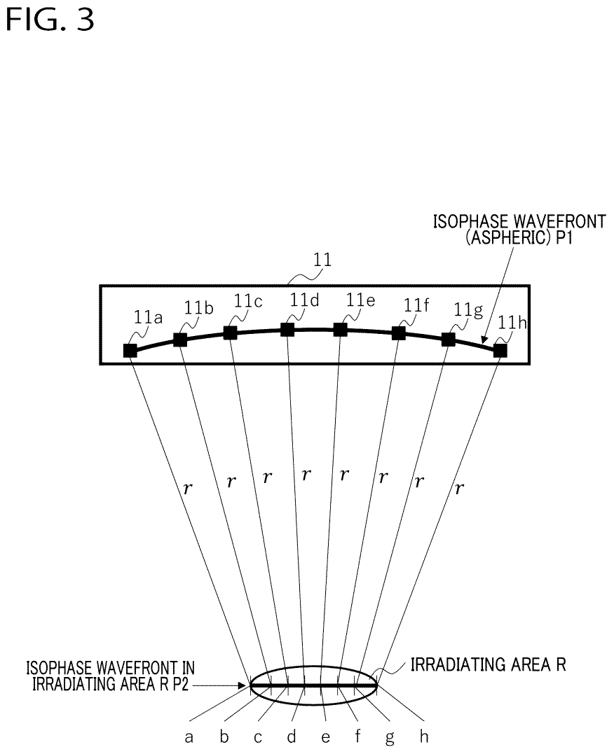

FIG. 3 is a schematic diagram of a sound wave source 11 according to the first embodiment. The sound wave source 11 includes a plurality of sound wave generators, hereinafter also referred to as “transducers” or “elements.” In this example, the sound wave source 11 includes eight sound wave generators: sound wave generator 11a, sound wave generator 11b, sound wave generator 11c, sound wave generator 11d, sound wave generator 11e, sound wave generator 11f, sound wave generator 11g and sound wave generator 11h. Sound wave generator 11a, sound wave generator 11b, sound wave generator 11c, sound wave generator 11d, sound wave generator 11e, sound wave generator 11f, sound wave generator 11g, and sound wave generator 11h emit sound waves to different points a, b, c, d, e, f, g, h respectively in the area R to be measured.

Each sound wave generator is arranged so that the distance between sound wave generator 11a and point a, the distance between sound wave generator 11b and point b, the distance between sound wave generator 11c and point c, the distance between sound wave generator 11d and point d, the distance between sound wave generator 11e and point e, the distance between sound wave generator 11f and point f, the distance between sound wave generator 11g and point g and the distance between sound wave generator 11h and point h each have r, the same value.

In other words, the distance between each sound wave generator and each point where the sound waves generated by the sound wave source reach is equal among all sound wave generators. Since the speed of sound transmitted between the sound wave source 11 and the irradiation area R is constant, if each sound wave is generated by each sound wave generator simultaneously, each sound wave will reach each point of the irradiation area R simultaneously. In this specification, when multiple sound waves reach each point on the measurement domain simultaneously in this manner, the plane composed of the points in the wavefront of each sound wave at a certain time is called an “isophase wavefront.” As shown in FIG. 3, when the points in the irradiation area R where each sound wave arrives are different, the isophase wavefront P1 is generally aspheric. In the irradiation area R, the isophase wavefront P2 coincides with the plane of the irradiation area R.

In this way, by arranging each of the sound wave generators 11a-11h of the sound wave source 11 on the isophase wavefront, when each of the sound wave generators generates sound waves simultaneously, the time at which each sound wave reaches the measurement target can be made to coincide. This allows the sound waves irradiated to each point in the irradiation area, also called “measurement target area”, to be in phase. Therefore, such a sound wave source configuration is suitable for the ASEM method.

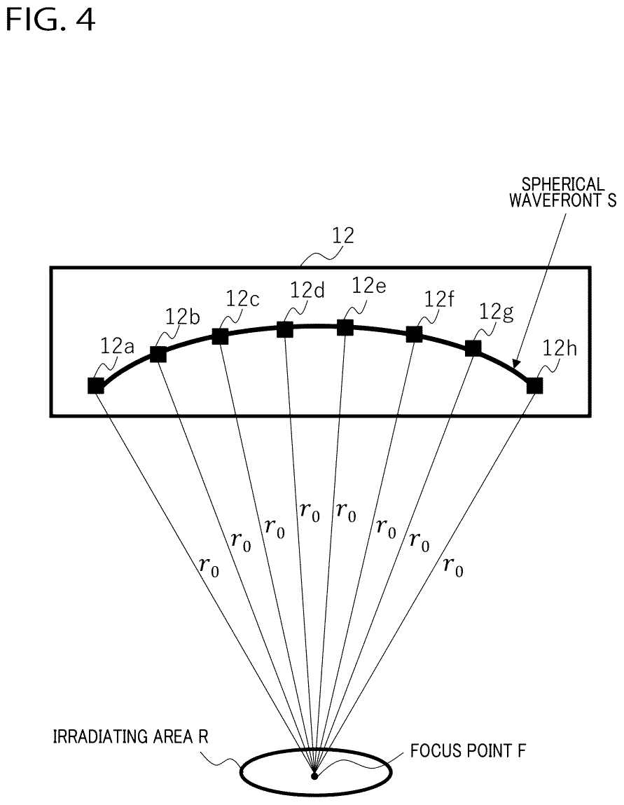

FIG. 4 is a schematic diagram of a sound wave source 12 according to a comparison example. The sound wave source 12 includes eight sound wave generators: sound wave generator 12a, sound wave generator 12b, sound wave generator 12c, sound wave generator 12d, sound wave generator 12e, sound wave generator 12f, sound wave generator 12g and sound wave generator 12h. These sound wave generators are arranged in a sphere of radius r₀ centered at the focus point F in the irradiation target area R. As a result, the sound waves generated simultaneously by each sound wave generator constitute a spherical wavefront S and converge at the focus point F within the irradiation area R. Sound waves reaching this focus point F are in phase.

This arrangement of sound wave generators is advantageous in the conventional ultrasonic echo method. This is because, as mentioned above, in the ultrasonic echo method, the spatial resolution can be higher and the echo signal obtained is larger if the irradiated sound waves are focused to as narrow an area as possible. On the other hand, such an arrangement of sound wave generators is not suitable for the ASEM method because the irradiation plane cannot be made large and the ASEM signal obtained cannot be large with this arrangement.

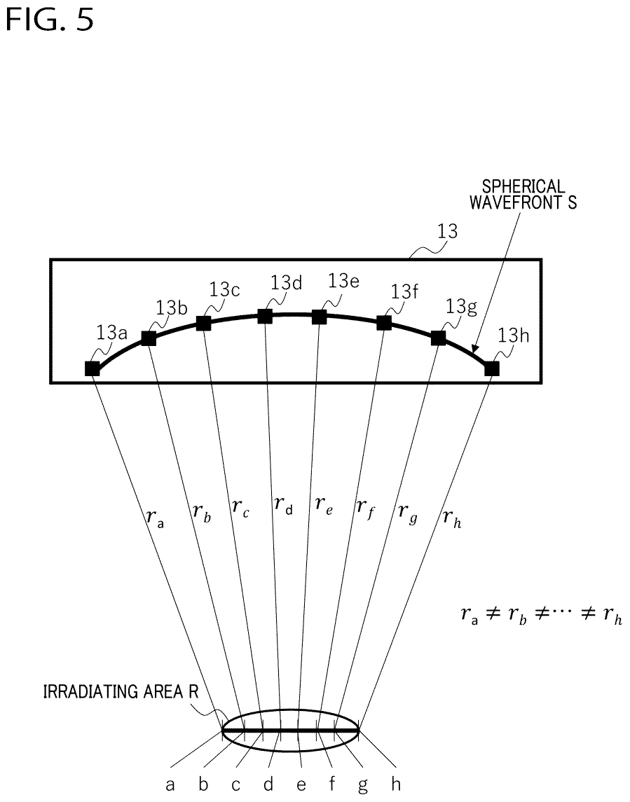

FIG. 5 is a schematic diagram of a sound wave source 13 according to another comparison example. The sound wave source 13 includes eight sound wave generators: sound wave generator 13a, sound wave generator 13b, sound wave generator 13c, sound wave generator 13d, sound wave generator 13e, sound wave generator 13f, sound wave generator 13g and sound wave generator 13h. These sound wave generators are arranged in a sphere centered at a predetermined point, as in

FIG. 3. However, the irradiation area R is off this center. Therefore, the sound waves generated by each of the sound wave generators 13a-13h constitute a spherical wavefront S and are irradiated to different points a-h in the irradiation area R. If the distance between the sound wave generator 13i and point i is rᵢ (i=a, b, . . . , h), rₐ≠r_{b}≠ . . . ≠rₕ.

When such an arrangement of sound wave generators is applied to the ASEM method, sound waves can be irradiated over a wide area of the measurement object, however the sound waves irradiated to each point cannot be in phase when each sound wave generator generates sound waves simultaneously.

### The Second Embodiment

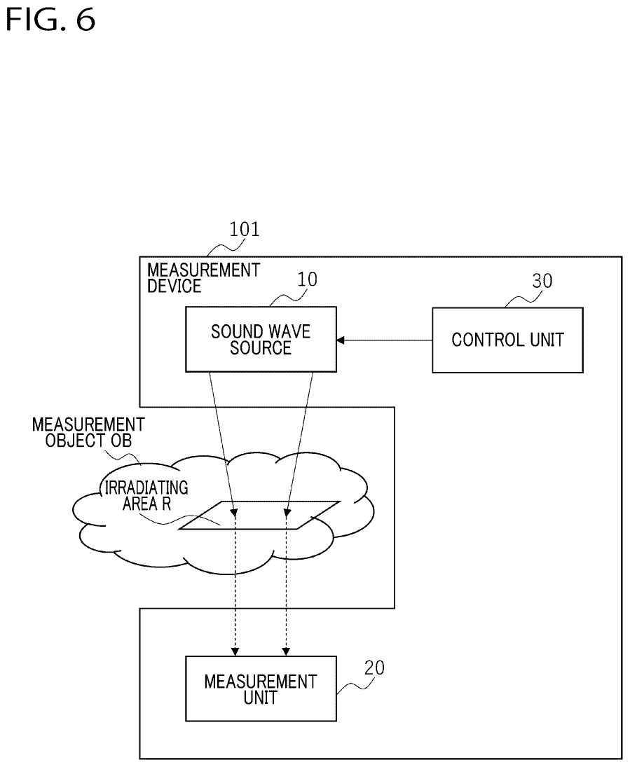

FIG. 6 is a functional block diagram of a measurement device 101 according to the second embodiment. The measurement device 101 also measures the measurement object OB non-invasively. The measurement device 101 comprises a sound wave source 10, a measurement unit 20 and a control unit 30. In other words, the measurement device 101 has the control unit 30 in addition to the configuration of the measurement device 100 in FIG. 2. The sound wave source 10 includes a plurality of sound wave generators. The other configurations of the measurement device 101 are the same as those of the measurement device 100.

The control unit 30 controls the timing of the sound wave generation of each of the plurality of sound wave generators so that the sound waves generated by the plurality of sound wave generators of the sound wave source 10 reach different parts of the measurement object OB at the same time.

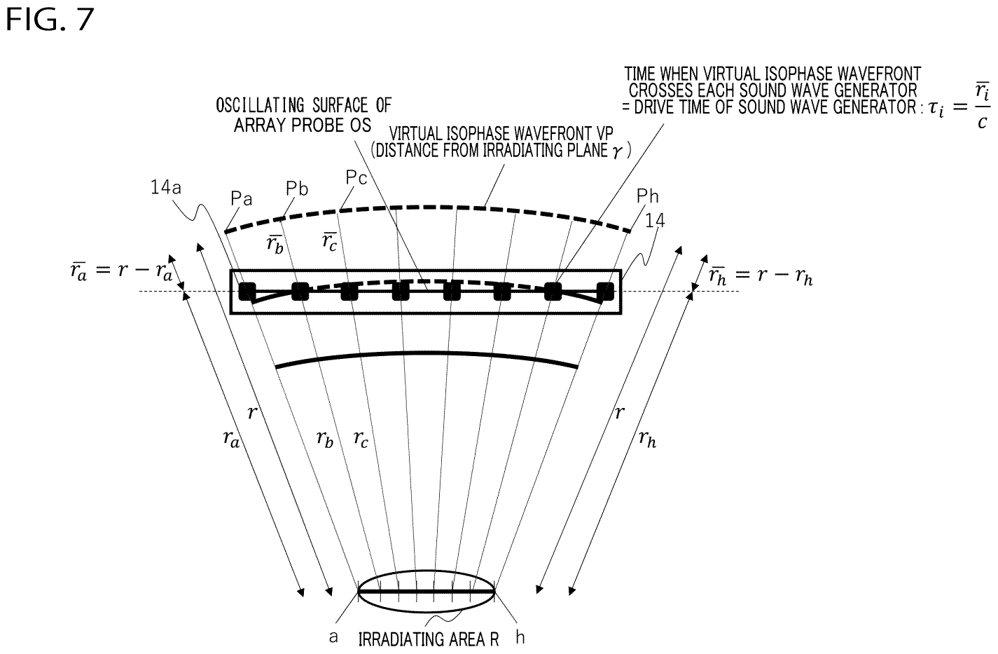

FIG. 7 is a schematic diagram of a sound wave source 14 according to the second embodiment. The sound wave source 14 includes eight sound wave generators: sound wave generator 14a, sound wave generator 14b, sound wave generator 14c, sound wave generator 14d, sound wave generator 14e, sound wave generator 14f, sound wave generator 14g and sound wave generator 14h. In this example, the sound wave source 14 is a one-dimensional array probe in which the sound wave generators 14a-14h are arranged in a substantially linear array. The oscillating surface of this one-dimensional array probe is indicated by OS. The sound wave generators 14a, 14b, 14c, 14d, 14e, 14f, 14g and 14h irradiate different points a, b, c, d, e, f, g and h in the measurement target area R with sound waves respectively.

FIG. 7 shows a hypothetical isophase wavefront VP on the far side of the sound wave source 14 as viewed from the irradiated area R. Let Pᵢ be the intersection point of the straight line connecting the sound wave generator 14i and point i in the irradiation area R and the virtual isophase wavefront VP (i=a, b, . . . , h, the same hereinafter). The distance between the point i in the irradiation area R and the point Pi in the virtual isophase wavefront VP is r. Note that since point Pi is on the isophase wavefront, r is common for all i (i =a, b, . . . , h). As in FIG. 5, let rᵢ be the distance between the sound wave generator 14i and point i in the irradiation area R. Also, let the distance between the sound wave generator 14i and the point Pi of the virtual isophase wavefront VP be:

$${\overline{r}}_{i} \qquad [ Equation 7 ]$$

### Then,:

$${\overline{r}}_{i} = r - {r}_{i} \qquad [ Equation 8 ]$$

holds.

The control unit 30 controls each of the sound wave generators 14i so that the drive time τᵢ of the sound wave generator 14i is:

$${τ}_{i} = \frac{{\overline{r}}_{i}}{c} \qquad [ Equation 9 ]$$

where c is the speed of sound in the sonic medium used. According to this control, it can be regarded that the virtual isophase wavefront VP propagates toward the irradiation area R and that each of the sound wave generators is driven to generate sound waves at the moment when the virtual isophase wavefront VP crosses each of the sound wave generators 14i. Therefore, each sound wave generated by each of the sound wave generators 14i reaches the irradiation area R simultaneously. In other words, by the control unit 30 controlling the timing of sound wave generation for each of the sound wave generators in this manner, the generated sound waves can reach different points in the predetermined measurement target area at the same time, regardless of the configuration of the arrangement of each sound wave generator.

As explained above, according to this embodiment, independent of the arrangement of the sound wave generators, it is possible to irradiate sound waves to a wide area of the measurement object while aligning the phases of the sound waves irradiated to each point in that area, thus obtaining a larger ASEM signal.

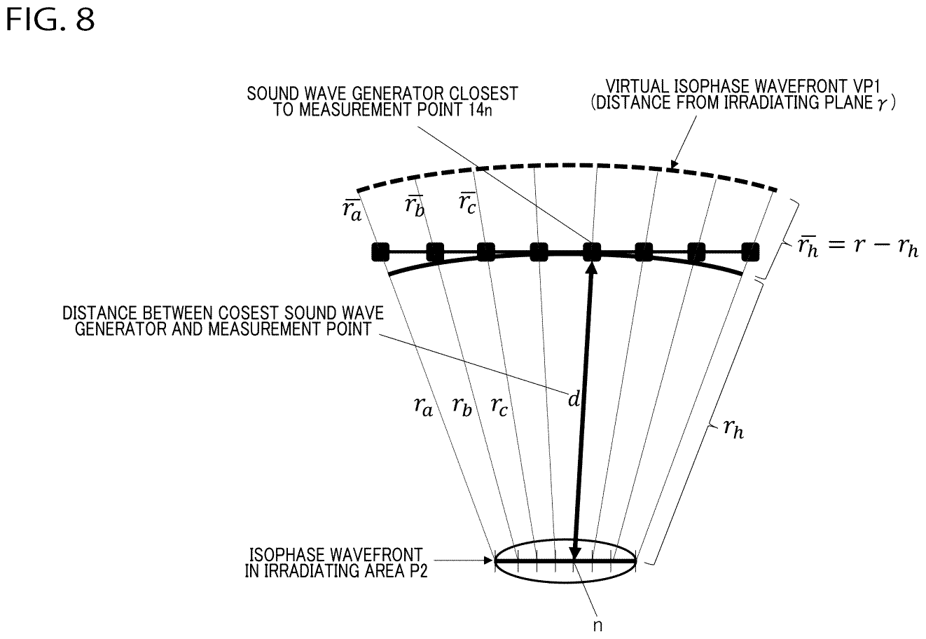

FIG. 8 is a schematic diagram of another sound wave source according to the second embodiment. FIG. 8 is basically the same as FIG. 7, but is unique in that it identifies the sound wave generator 14n that is closest to the measurement point, and the distance between the sound wave generator 14n and the corresponding measurement point n is d. The control unit 30 performs control so that the drive time of the sound wave generator 14n and the measurement start time of the measurement unit 20 are equal.

According to this embodiment, the trigger can be sent to the measurement unit 20, e.g., digitizer, based on the time when sound waves are generated by the sound wave generator closest to the irradiated surface among multiple sound wave generators.

### The Third Embodiment

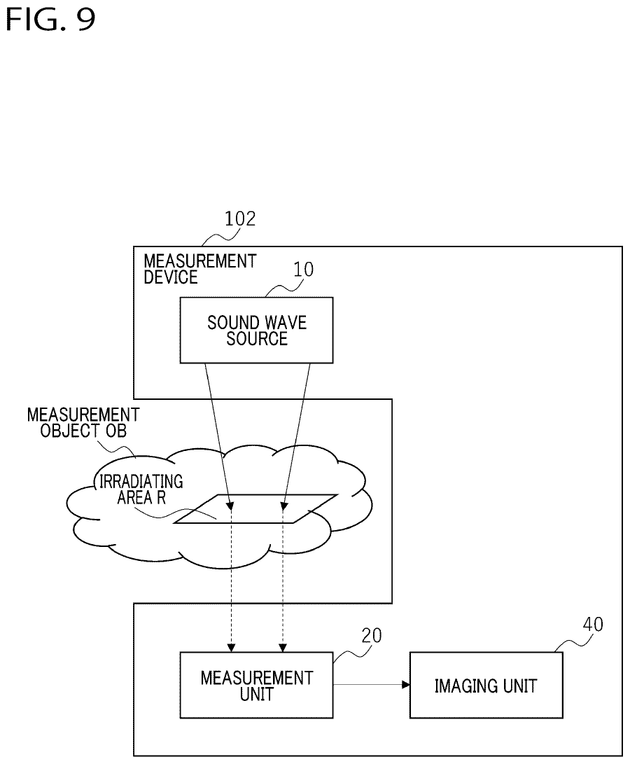

FIG. 9 is a functional block diagram of a measurement device 102 according to the third embodiment. The measurement device 102 also measures the measurement object OB non-invasively. The measurement device 102 has a sound wave source 10, a measurement unit 20 and an imaging unit 40. In other words, the measurement device 102 has the imaging unit 40 in addition to the configuration of the measurement device 100 in FIG. 2. The other configurations of the measurement device 102 are the same as those of the measurement device 100.

The imaging unit 40 images the signal measured by the measurement unit 20. For example, imaging may be performed by giving one or more pixels to each of the measurement areas of the measurement objects OBs and generating a two-dimensional digital image according to the presence or absence and intensity of the signals measured by the measurement unit 20. This allows visualization of the characteristics of the object of interest at each point of the measurement object OB by creating an image.

### The Fourth Embodiment

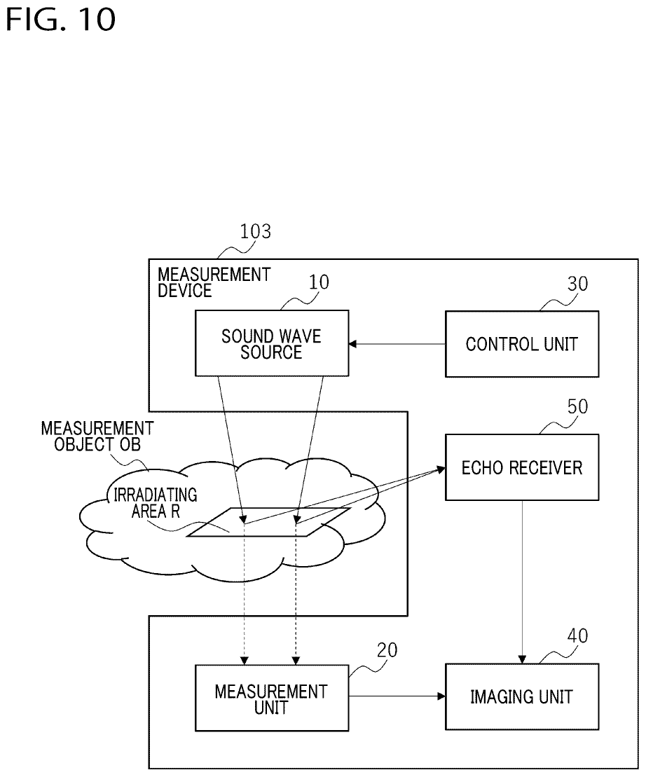

FIG. 10 is a functional block diagram of a measurement device 103 according to the fourth embodiment. The measurement device 103 also measures the measurement object OB non-invasively. The measurement device 103 includes a sound wave source 10, a measurement unit 20, an imaging unit 40, and an echo receiver 50. In other words, the measurement device 103 has the echo receiver 50 in addition to the configuration of the measurement device 102 in FIG. 9. The sound wave source 10 includes a plurality of sound wave generators. The other configurations of the measurement device 103 are the same as those of the measurement device 102.

The echo receiver 50 receives echo signals from the points where each of the plurality of sound wave generators irradiates sound waves. The echo signals are sound echoes of the sound waves irradiated to each point of the measurement object OB by each of the sound wave generators. The echo receiver 50 may be configured to operate in conjunction with the sound wave source 10 to efficiently receive echo signals, or it may be fixed at one point and configured to receive echo signals emitted from any direction.

The control unit 30 controls so that the drive time of the sound wave generator at the shortest distance among the distances between each point of the measurement object OB irradiated with sound waves by the plurality of sound wave generators and each sound wave generator, the measurement start time of the measurement unit 20, and the echo reception start time of the echo receiver 50 are equal. The imaging unit 40 images both the signal measured by the measurement unit 20 and the echo signal. This control synchronizes the measurement start time of the measurement unit 20 with the echo signal reception start time, so that both images can be made clear.

According to this embodiment, the measurement object can be measured more accurately by combining the ASEM method and the echo method.

### The Fifth Embodiment

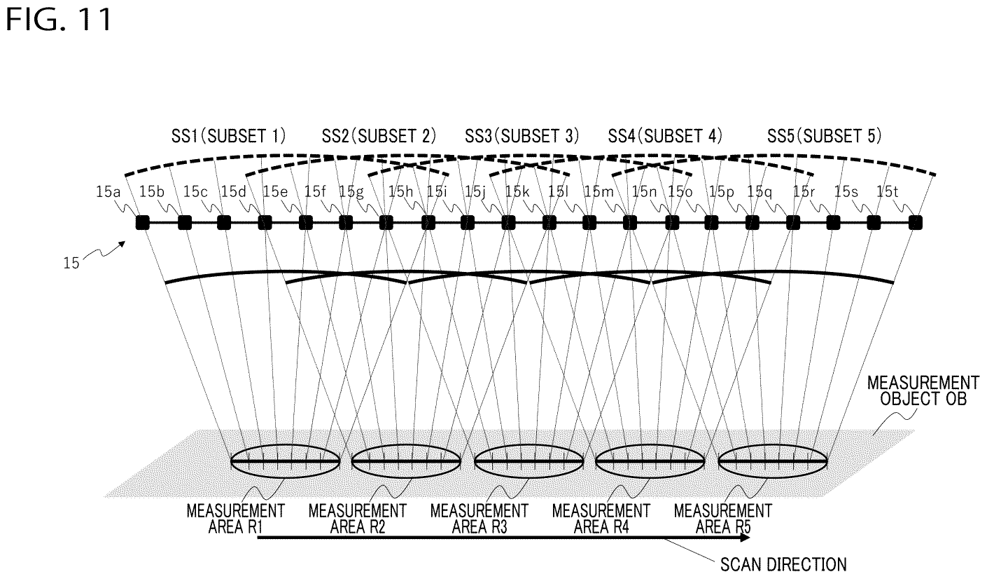

FIG. 11 is a schematic diagram of a sound wave source 15 according to the fifth embodiment. The sound wave source 15 comprises 20 sound wave generators: sound wave generator 15a, sound wave generator 15b, sound wave generator 15c, sound wave generator 15d, sound wave generator 15e, sound wave generator 15f, sound wave generator 15g, sound wave generator 15h, sound wave generator 15i, sound wave generator 15j, sound wave generator 15k, sound wave generator 151, sound wave generator 15m, sound wave sound wave generator 15n, sound wave generator 150, sound wave generator 15p, sound wave generator 15q, sound wave generator 15r, sound wave generator 15s, sound wave generator 15t. The sound wave generators 15a-15t are arranged in a substantially linear array and constitute a one-dimensional array probe.

The sound wave generators 15a-15t constitute a group comprising a plurality of sound wave generators including a subset of sound wave generators selected from each of these. Specifically, this group comprises subset 1 (SS1), which consists of eight sound wave generators: sound wave generator 15a, sound wave generator 15b, sound wave generator 15c, sound wave generator 15d, sound wave generator 15e, sound wave generator 15f, sound wave generator 15g and sound wave generator 15h; subset 2 (SS2), which consists of eight sound wave generators: sound wave generator 15d, sound wave generator 15e, sound wave generator 15f, sound wave generator 15g, sound wave generator 15h, sound wave generator 15i, sound wave generator 15j, sound wave generator 15k; subset 3 (SS3), which consists of eight sound wave generators: sound wave generators 15g, sound wave generator 15h, sound wave generator 15i, sound wave generator 15j, sound wave generator 15k, sound wave generator 15l, sound wave generator 15m, sound wave generator 15n; Subset 4 (SS4), which consists of eight sound wave generators: sound wave generator 15j, sound wave generator 15k, sound wave generator 15l, sound wave generator 15m, sound wave generator 15n, sound wave generator 15o, sound wave generator 15p, sound wave generator 15q; and Subset 5 (SS5), which consists of eight sound wave generators: sound wave generator 15m, sound wave generator 15n, sound wave generator 15o, sound wave generator 15p, sound wave generator 15q, sound wave generator 15r, sound wave generator 15s, sound wave generator 15t.

In this embodiment, subset 1 (SS1) of the sound wave generators scans the measurement area R1 of the measurement object OB, subset 2 (SS2) of the sound wave generators scans the measurement area R2 of the measurement object OB, subset 3 (SS3) of the sound wave generators scans the measurement area R3 of the measurement object OB, subset 4 (SS4) of the sound wave generators scans the measurement area R4 of the measurement object OB and subset 5 (SS5) of the sound wave generators scans the measurement area R5 of the measurement object OB, each scanning over the surface of the measurement object OB.

According to this embodiment, a wide area of the measurement object OB can be measured by scanning it area by area.

### The Sixth Embodiment

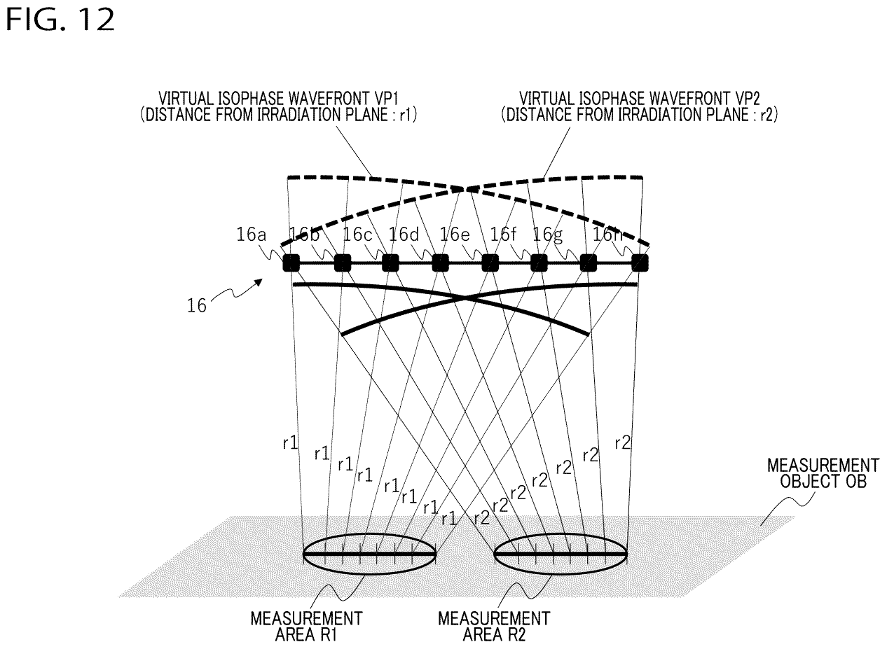

FIG. 12 is a schematic diagram of a sound wave source 16 according to the sixth embodiment. The sound wave source 16 includes eight sound wave generators: sound wave generator 16a, sound wave generator 16b, sound wave generator 16c, sound wave generator 16d, sound wave generator 16e, sound wave generator 16f, sound wave generator 16g and sound wave generator 16h. The sound wave generators 16a to 16h are arranged in a substantially linear array and constitute a one-dimensional array probe.

The control unit 30 controls the timing of sound wave generation of each sound wave generator so that the sound wave generators 16a to 16h measure the measurement area R1 of the measurement object OB at the first timing and measure the measurement area R2 at the second timing. This causes the sound wave generators 16a to 16h to measure the measurement area R1 and R2 at different timings, each scanning over the surface of the measurement object OB.

In this case, the control unit 30 controls each sound wave generator so that a virtual isophase wavefront propagates toward the irradiated area and each sound wave generator is driven to generate sound waves at the moment when the virtual isophase wavefront crosses each sound wave generator, as described in the second embodiment. Specifically, the control unit 30 drives the sound wave generators 16a to 16h so that a virtual isophase wavefront VP1 with a distance of r1 from each point of the measurement area R1 is formed for the measurement area R1 and a virtual isophase wavefront VP2 with a distance of r2 from each point of the measurement area R2 is formed for the measurement area R2. As a result, each sound wave generated by each of the sound wave generators 16a to 16h reaches each point simultaneously with respect to both the measurement area R1 and the measurement area R2.

According to this embodiment, a wide area of the measurement object OB can be scanned and measured area by area.

### The Seventh Embodiment

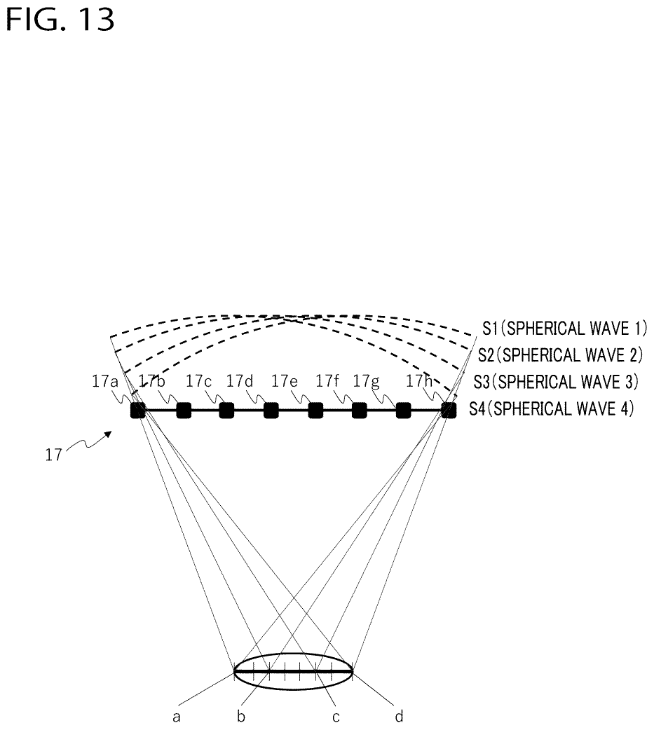

FIG. 13 is a schematic diagram of a sound wave source 17 according to the seventh embodiment. The sound wave source 17 includes eight sound wave generators: sound wave generator 17a, sound wave generator 17b, sound wave generator 17c, sound wave generator 17d, sound wave generator 17e, sound wave generator 17f, sound wave generator 17g and sound wave generator 17h. The sound wave generators 17a to 17h are arranged in a substantially linear array, constituting a one-dimensional array probe.

The sound wave generators 17a to 17h simultaneously generate spherical wave 1 (S1) to irradiate point a in the measurement target area at the first timing, spherical wave 2 (S2) to irradiate point b in the measurement target area at the second timing, spherical wave 3 (S3) to irradiate point c in the measurement target area at the third timing and spherical wave 4 (S4) to irradiate point d in the measurement target area at the fourth timing. In other words, in this embodiment, all sound wave generators irradiate sound waves, i.e., spherical waves, to one point in the measurement area at each timing. In other words, the sound wave i.e., spherical wave, irradiated from each sound wave generator at each timing is focused to one point. Namely, in this embodiment, the sound wave generated at each timing is a spherical wave.

The control unit 30 controls the sound wave source 17 so that the time when the spherical wave 1 (S1) generated at the first timing reaches point a, the time when the spherical wave 2 (S2) generated at the second timing reaches point b, the time when the spherical wave 3 (S3) generated at the third timing reaches point c and the time when the spherical wave 4 (S4) generated at the fourth timing reaches point d coincide. In other words, the control unit 30 controls the timing of sound wave generation for each of the sound wave generators 17a to 17h so that the sound waves, spherical waves, generated at all generation timings reach different points, i.e., point a, point b, point c and point d, at the same time.

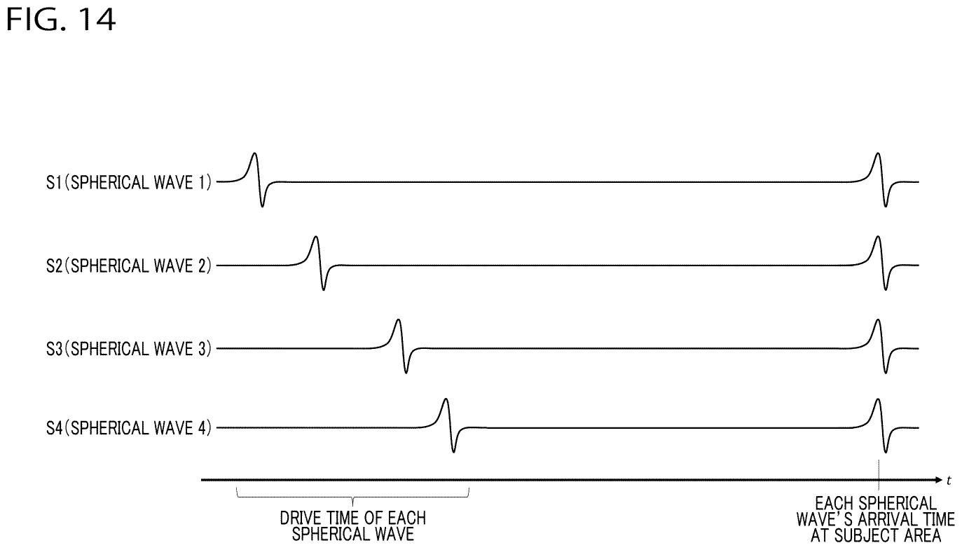

FIG. 14 is a schematic diagram showing a vibration profile of each spherical wave at the time of driving and at the time it reaches measurement target area.

In this embodiment, sound waves, spherical waves, are generated using all eight sound wave generators 17a to 17h, and these are concentrated on the respective points in the measurement object. In this case, the sound waves can reach eight times stronger than when sound waves generated by a single sound wave generator are irradiated. Therefore, according to this embodiment, the sound waves irradiated to the four points in the measurement object can be in phase, while the ASEM signal generated can be further enhanced.

### The Eighth Embodiment

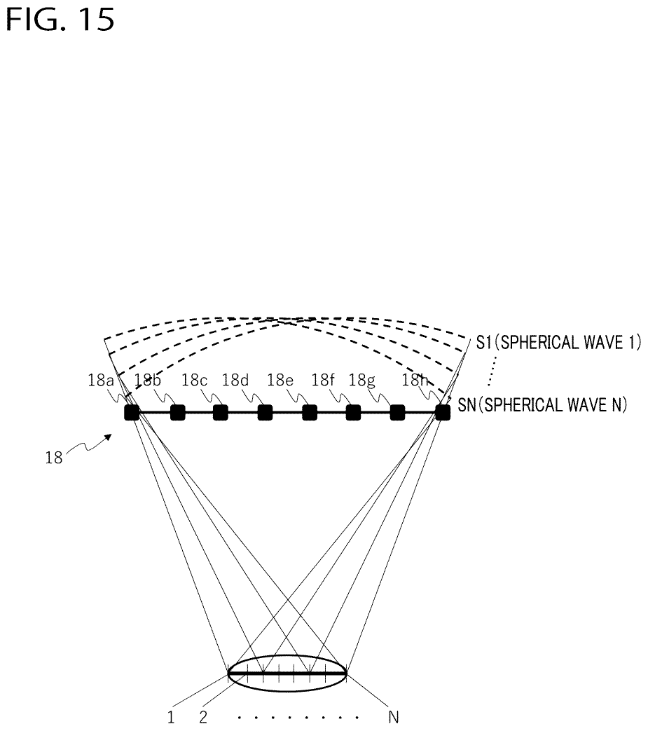

FIG. 15 is a schematic diagram of a sound wave source 18 according to the eighth embodiment. The sound wave source 18 includes eight sound wave generators: sound wave generator 18a, sound wave generator 18b, sound wave generator 18c, sound wave generator 18d, sound wave generator 18e, sound wave generator 18f, sound wave generator 18g and sound wave generator 18h. The sound wave generators 18a to 18h are arranged in a substantially linear array and constitute a one-dimensional array probe.

In the sixth embodiment, each sound wave generator generates sound waves, spherical waves, four times. On the other hand, in this embodiment, the number is increased to N times. That is, sound wave generators 18a to 18h simultaneously generate spherical wave 1 (S1) to irradiate point 1 in the measurement target area at the first timing, simultaneously generate spherical wave 2 (S2) to irradiate point 2 in the measurement target area at the second timing, and repeat similar sound wave generation to simultaneously generate spherical wave N (SN) to irradiate point N in the measurement target area at the Nth timing. The sound waves generated at each timing are spherical waves as in the sixth embodiment.

Because the value of N is sufficiently large, the sound waves, spherical waves, generated by the sound wave generators 18a-18h form each continuous pulses.

The control unit 30 controls the timing of sound wave generation of each of the sound wave generators 18a-18h so that the sound waves generated at all generation timings, N times, reach different points, i.e., point 1, point 2, point N, at the same time.

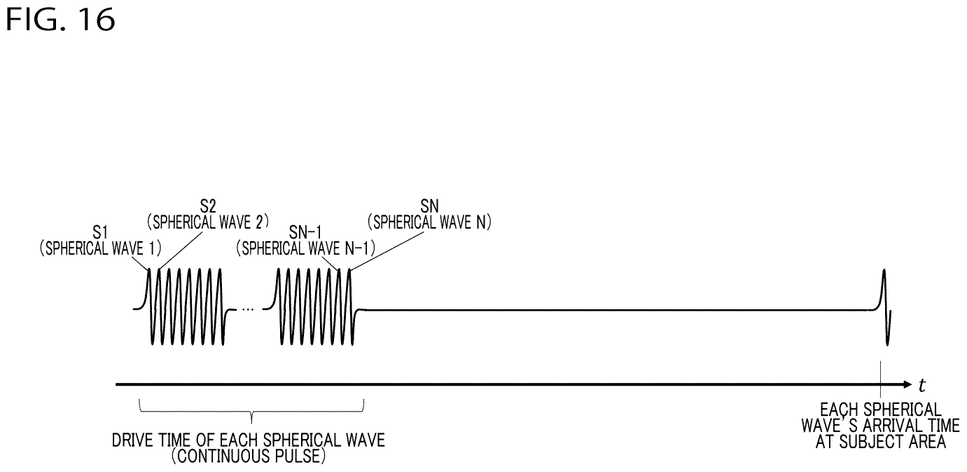

FIG. 16 is a schematic diagram showing the vibration profile of each spherical wave at the driven time and at the time it reaches measurement target area. Note that continuous pulses are oscillated at the drive time of each spherical wave.

According to this embodiment, the phases of the sound waves irradiated to a very large number of points, N, in the measurement target area can be aligned. This makes it possible to measure many points in the measurement object, thereby improving measurement accuracy.

### The Ninth Embodiment

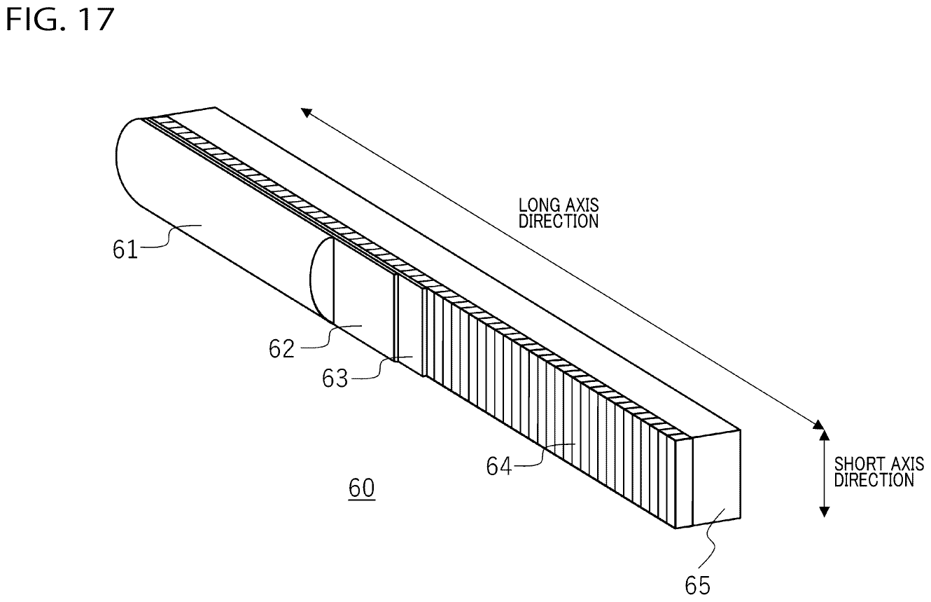

FIG. 17 shows a schematic diagram of the one-dimensional array probe 60 according to the ninth embodiment. The one-dimensional array probe 60 takes a structure in which, from the top, acoustic lens 61, matching layers 62 and 63, transducer 64 and packing material 65 are stacked. Each transducer 64 is arranged in a comb shape along the long axis direction.

The focal length of the one-dimensional array probe 60 in the short axis direction is fixed by the acoustic lens 61 provided on the one-dimensional array probe 60. Therefore, the focal length of the aspheric wavefront, isophase wavefront, should be aligned with the focal length of the acoustic lens 61.

### The Tenth Embodiment

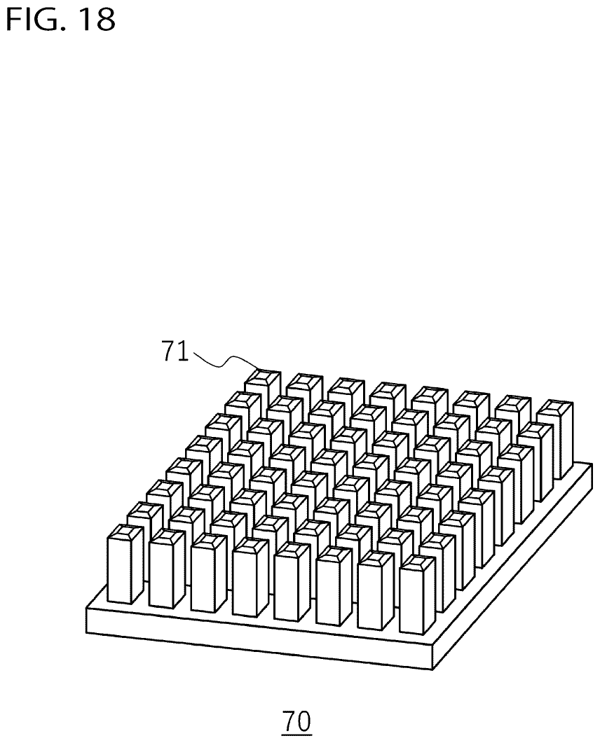

FIG. 18 is a schematic diagram of a two-dimensional array probe 70 arranged in a substantially plane according to the tenth embodiment. The two-dimensional array probe 70 is composed of transducers 71 arranged in a two-dimensional shape.

In a two-dimensional array probe, the focal length can be controlled by the array in both the long and short axis directions. Therefore, the focal length of the aspheric wavefront, isophase wavefront, can be set freely. In addition, the advantage is that the width of the irradiation plane can be widened in both the long and short axis directions.

### The Eleventh Embodiment

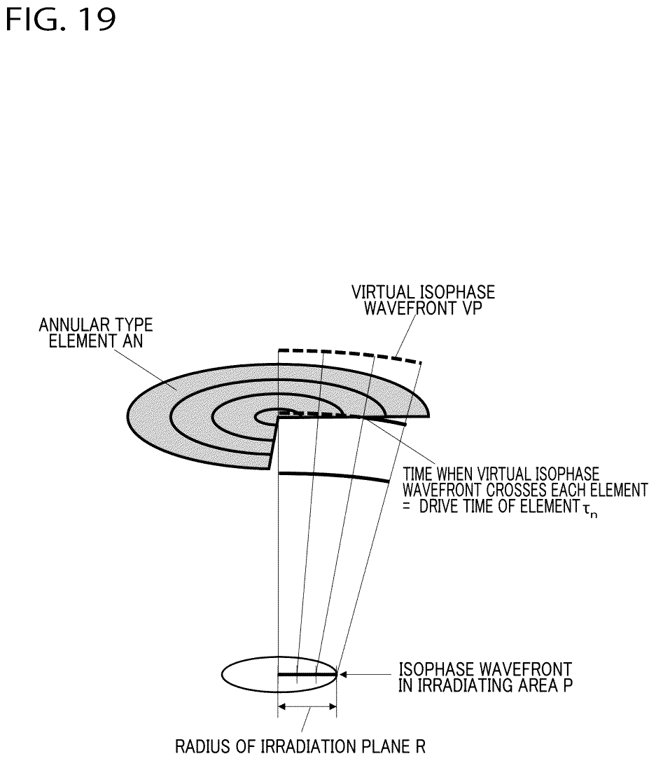

FIG. 19 is a schematic diagram of an annular array probe of the eleventh embodiment. This annular array probe takes a structure in which a plurality of annular type elements AN are concentrically arranged.

The method of determining the drive time of the annular array probe according to this embodiment is as follows.
(1) Set the radius R of the irradiation plane.
(2) Divide the irradiation plane into n concentric circles and assign each to n annular type elements AN.
(3) Assume a virtual isophase wavefront VP, i.e., aspheric wavefront to be generated, for all annular elements AN, assuming that the distance between the irradiation surface and the annular elements AN is the same r. The annular element AN is driven, i.e., excitation pulses is input, at the moment when the virtual isophase wavefront VP crosses the annular element AN.
(4) Geometrically calculate the actual distance rₙ between the divided irradiation plane and the nth annular element AN.
(5) From the difference between rₙ and r, calculate the distance between the virtual isophase wavefront VP and the annular element AN:

$${\overline{r}}_{n} \qquad [ Equation 10 ]$$

is calculated.
(6) Considering that the virtual isophase wavefront VP travels through the sound wave medium at the speed of sound c, the time when the virtual isophase wavefront VP crosses the nth annular element AN, i.e., the drive time τₙ of the nth annular element AN, is determined as follows.

$${τ}_{n} = \frac{{\overline{r}}_{n}}{c} \qquad [ Equation 11 ]$$

According to this embodiment, the radius of the irradiation plane and the focal distance of the aspheric wavefront, isophase wavefront, can be set freely, similar to the two-dimensional array probe of the tenth embodiment. Furthermore, the two-dimensional array probe has the disadvantage that the pulse control and measurement system is complicated due to the large number of elements. Annular array probes have the advantage of simplifying this problem. However, it is difficult for annular array probes to form an irradiation plane that is off the central axis.

### The Twelfth Embodiment

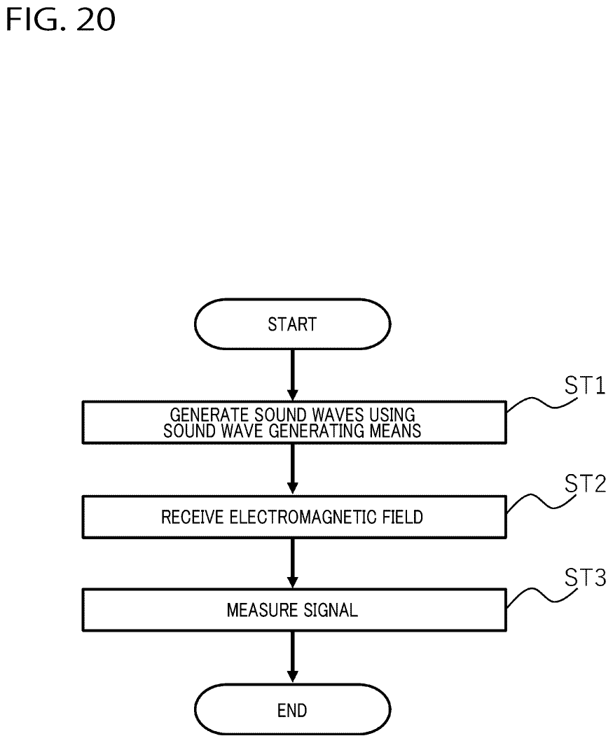

FIG. 20 is a flowchart of a method for non-invasively measuring a measurement object according to the twelfth embodiment. This method includes the step ST1 of generating sound waves using a sound wave generating means, the step ST2 of receiving an electromagnetic field and the step ST3 of measuring a signal.

In the step ST1, the measurement method generates sound waves using sound wave generating means to irradiate different points in a measurement object, respectively. In the step ST2, the measurement method receives the electromagnetic field generated at each point to which the sound wave was irradiated. In the step ST3, the measurement method measures a signal indicating at least one characteristic selected from the group comprising electrical characteristics, magnetic characteristics, electromechanical characteristics and magnetomechanical characteristics of the measurement object, based on at least one selected from the group comprising the intensity, phase and frequency of the received electromagnetic field.

Sound waves generated by the sound wave generating means reach different points within a predetermined area of the measurement object at the same time.

According to this measurement method, a larger ASEM signal can be obtained because the phases of the sound waves irradiated to each point in the area can be aligned while irradiating sound waves to a wide measurement target area.

### Verification

The inventors conducted experiments to verify the effects of the embodiments described above.

### Experiment 1

Experiment 1 is an experiment to confirm that the irradiated area is expanded by aspheric ultrasonic irradiation.

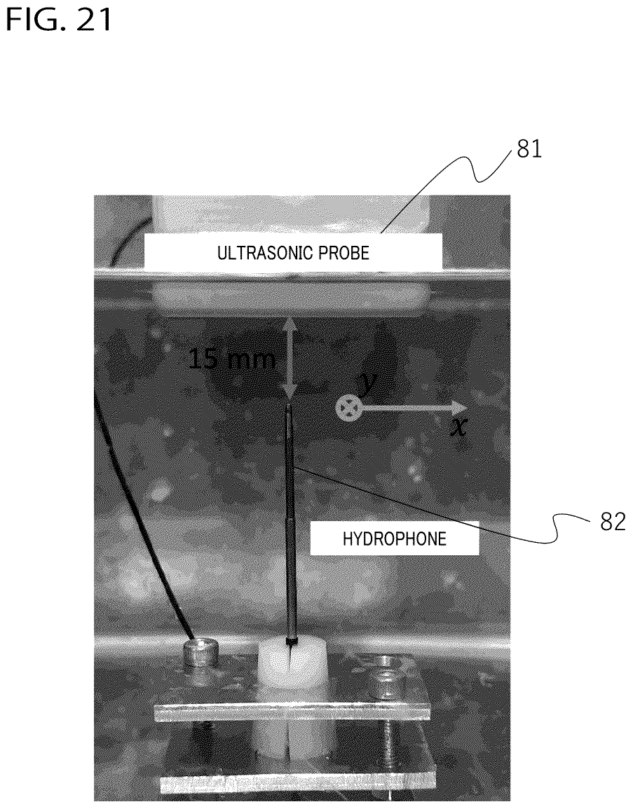

FIG. 21 is a photograph showing the setup 80 of Experiment 1. This experimental system consists of a one-dimensional ultrasonic array probe 81 in the x-direction and a hydrophone 82.

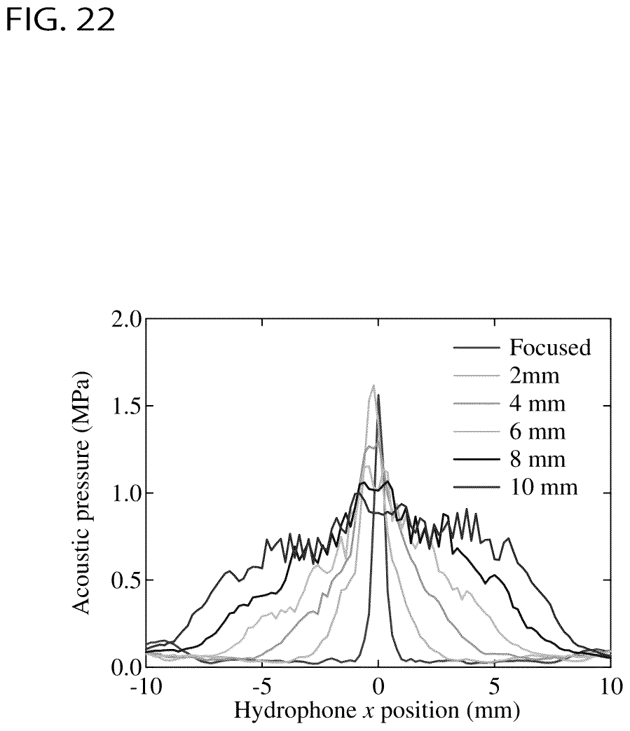

FIG. 22 is a graph showing the relationship between the x-directional position of the hydrophone 82 and the sound pressure in Experiment 1. It can be seen that the irradiated area is expanded almost as calculated.

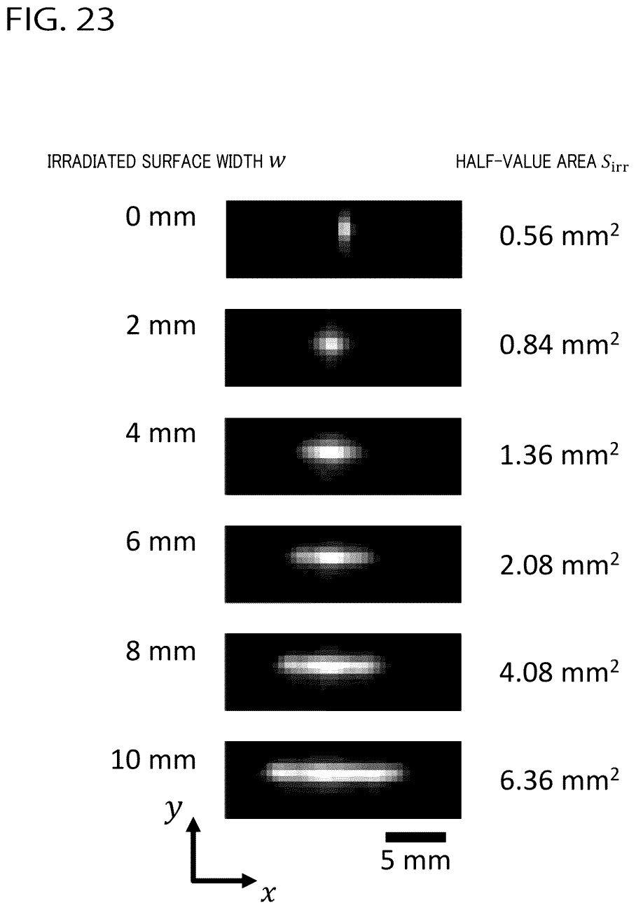

FIG. 23 is a photograph showing the half-value area Sirr against the irradiated surface width w in Experiment 1.

### Experiment 2

Experiment 2 is an experiment to confirm that aspheric ultrasound irradiation increases the ASEM signal amplitude.

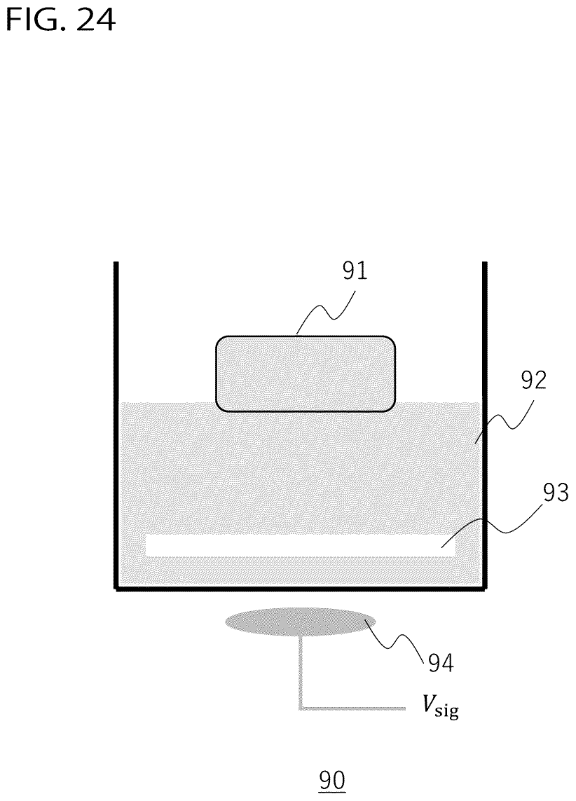

FIG. 24 shows a schematic diagram showing the setup 90 for Experiment 2. This setup 90 consists of an ultrasonic array probe 91, water 92, i.e., sonic medium, an acrylic board 93, i.e., measurement target, and a copper plate antenna 94.

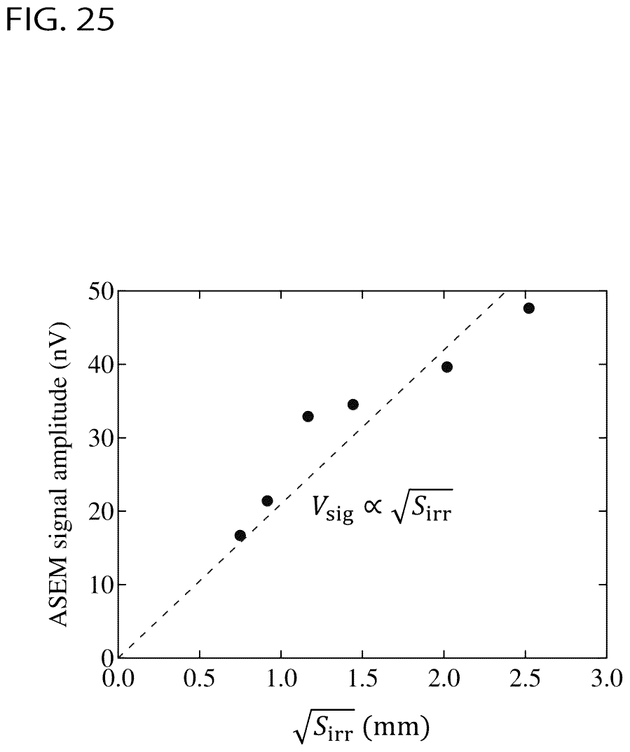

FIG. 25 is a graph showing the relationship between the square root of the irradiated area:

$$\sqrt{{S}_{i r r}}$$

and the amplitude of the ASEM signal V_{sig}. As shown in FIG. 25, V_{sig} is proportional to:

$$\sqrt{{S}_{irr}} \qquad [ Equation 12 ]$$

This is consistent with the expected result.

### Experiment 3

Experiment 3 is an experiment to confirm that the optimal focal length for aspheric ultrasonic irradiation is the focal length of the array probe acoustic lens.

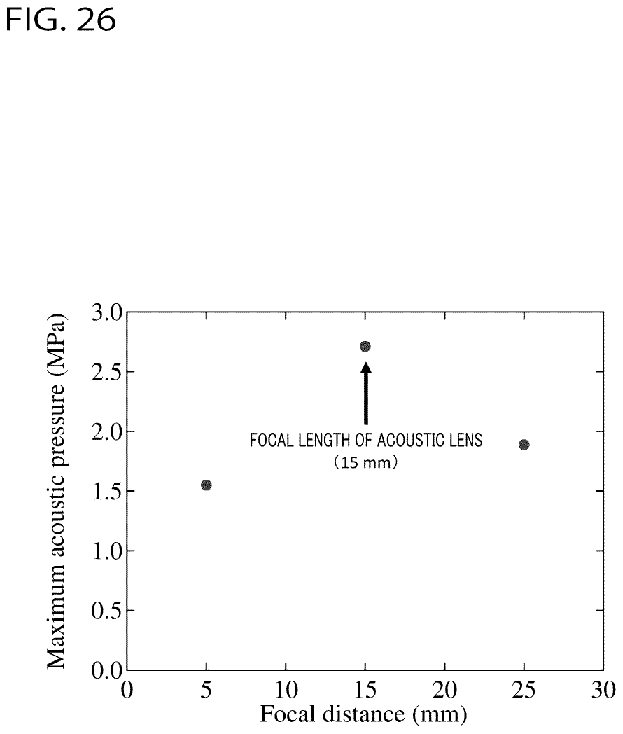

FIG. 26 is a graph showing the relationship between the focal length and the maximum sound pressure obtained. As shown in FIG. 26, the maximum sound pressure is maximum at 15 mm, which corresponds to the focal length of the acoustic lens, and is consistent with the expected result.

### Experiment 4

Experiment 4 is an experiment to image the ASEM response of the human radius using aspheric ultrasound irradiation.

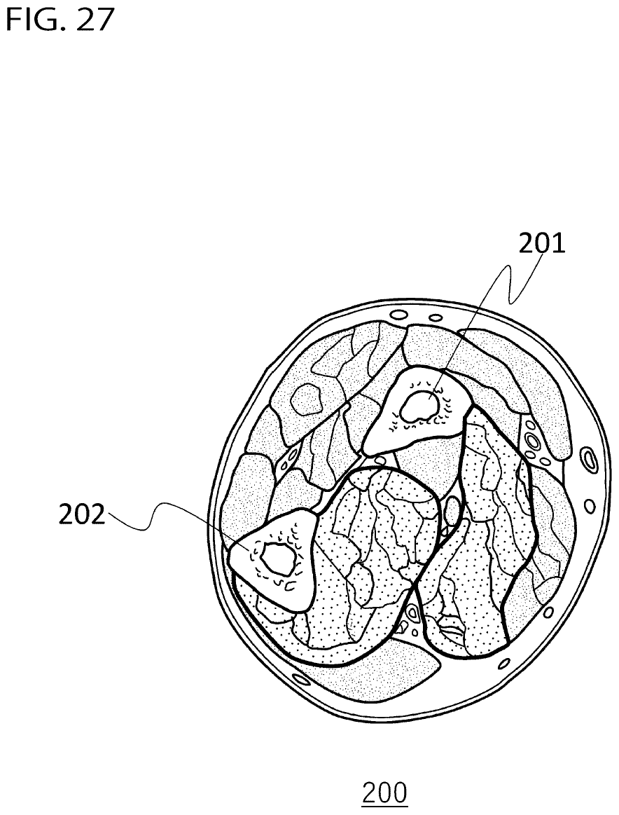

FIG. 27 is a schematic diagram of a human arm 200 in cross section showing the radius 201 and ulna 202.

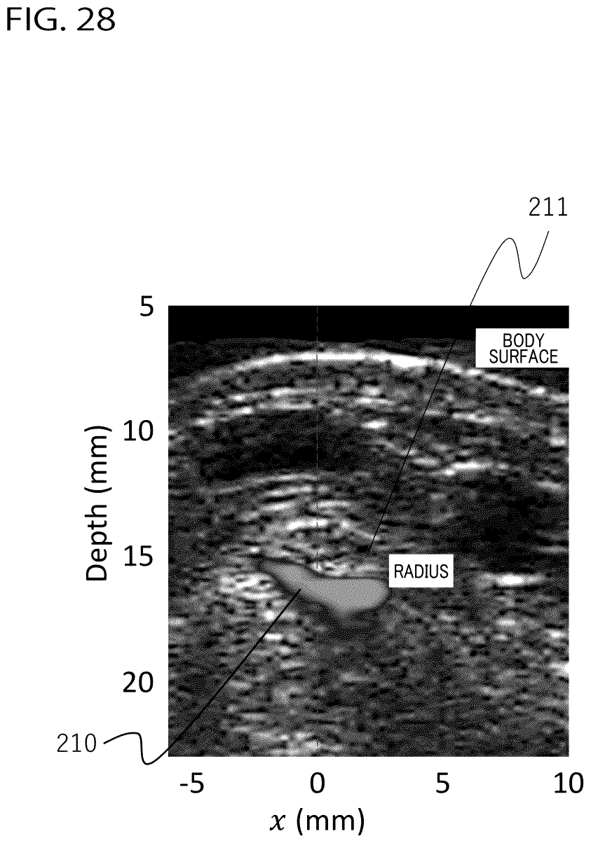

FIG. 28 is a photograph of an image 210 obtained from an ASEM signal and an image 211 obtained from an echo signal, superimposed. Since the thickness of the human radius 201 is about 8-10 mm, the irradiation plane diameter was set to 4 mm, half of that thickness, for the measurement. In contrast, for normal focus, the irradiation plane diameter is about 1 mm. The high signal-to-noise ratio due to aspheric ultrasound irradiation can be used to image the ASEM response of the human radius 201.

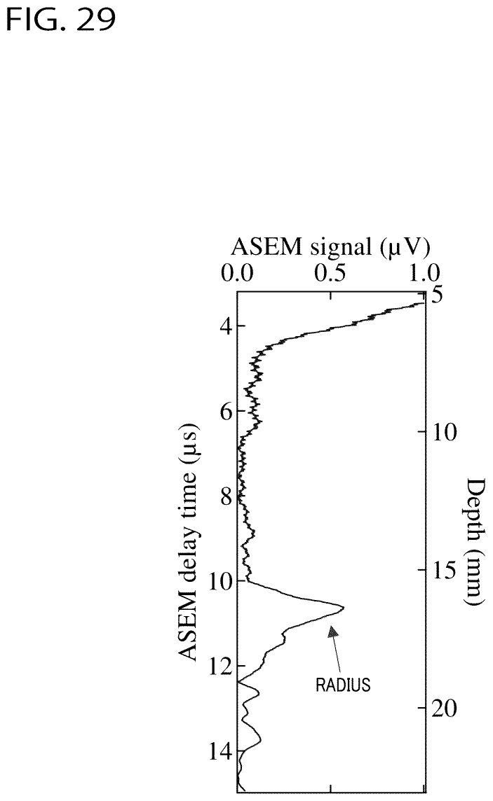

FIG. 29 shows the time variation of the ASEM signal. At time 10.5 μs, a peak indicating the radius 201 can be seen.

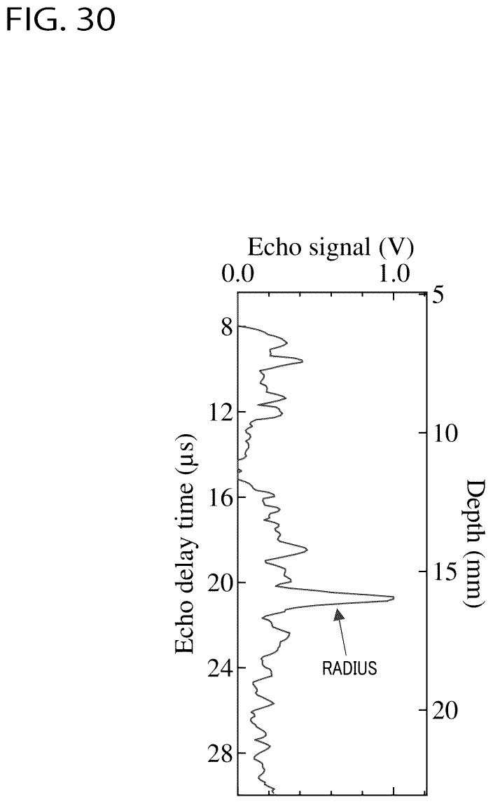

FIG. 30 shows the time variation of the echo signal. At time 21 μs, a peak indicating radius 201 is seen. Compared to FIG. 29, the peak indicating radius 201 appears twice as long later because the echo signal takes twice as long for a round trip.

The above is a detailed description of the embodiments of the present disclosure. It is understood by those skilled in the art that these embodiments are examples, that various variations and modifications are possible within the claims of the present disclosure, and that such variations and modifications are also within the claims of the present disclosure. Accordingly, the description and drawings herein should be treated as illustrative, not limiting.

### Variations

Variations are described below. In the drawings and descriptions of the variations, identical or equivalent components and members to those in the embodiment are marked with the same symbols. Explanations that duplicate those of the embodiment will be omitted as appropriate, and emphasis will be placed on explanations of configurations that differ from the first embodiment.

In the embodiment, the sound wave generator irradiated sound waves to the measurement object using an acoustic lens. However, this is not limited to this, and the sound wave generator may also irradiate sound waves using, for example, a phased array method. According to this modification, the degree of freedom of configuration can be increased.

The variant has the same actions and effects as the embodiment.

Any combination of the above mentioned embodiments and variants is also useful as an embodiment of the present disclosure. The new embodiments resulting from the combination will have the same effects as each of the embodiments and variations combined.

What is claimed is:

1. A measurement device for non-invasively measuring a measurement object, comprising:
a sound wave source including a plurality of sound wave generators that irradiates sound waves to different points in the measurement object; and
a measurement unit that receives an electromagnetic field generated at each point of the measurement object to which the sound waves are irradiated, and measures a signal indicating at least one characteristic selected from the group comprising electrical characteristics, magnetic characteristics, electromechanical characteristics and magnetomechanical characteristics of the measurement object based on at least one selected from the group comprising the intensity, phase and frequency of the received electromagnetic field,
wherein the isophase wavefront of the sound wave is aspheric,
wherein the sound waves generated by the sound wave source reach at different points in the measurement object simultaneously and
wherein the sound waves irradiated to each point in the measurement object are in phase.

2. The measurement device according to claim 1,
further comprising a control unit that controls the timing of the sound wave generation of each of the plurality of sound wave generators so that the generated sound waves reach different points in the measurement object at the same time.

3. The measurement device according to claim 1,
wherein the sound wave source is a one-dimensional array probe in which the plurality of sound wave generators are arranged in a substantially linear array.

4. The measurement device according to claim 2,
wherein the control unit controls so that the drive time of the sound wave generator at the shortest distance among the distances between each point of the measurement object irradiated with sound waves by the plurality of sound wave generators and each sound wave generator and the measurement start time of the measurement unit are equal.

5. The measurement device according to claim 1,
further comprising an imaging unit that images the signal measured by the measurement unit.

6. The measurement device according to claim 5,
further comprising an echo receiver that receives echo signals from the points where each of the plurality of sound wave generators irradiates sound waves,
wherein the control unit controls so that the drive time of the sound wave generator at the shortest distance among the distances between each point of the measurement object irradiated with sound waves by the plurality of sound wave generators and each sound wave generator, the measurement start time of the measurement unit and the echo reception start time of the echo receiver are equal and
wherein the imaging unit images both the signal measured by the measurement unit and the echo signal.

7. The characteristics measurement device according to claim 2,
comprising a plurality of group of the sound wave generators including a subset of sound wave generators selected from the plurality of sound wave generators,
wherein each of the plurality of group of the sound wave generators measures a different area of the measurement object, each scanning over the surface of the measurement object.

8. The characteristics measurement device according to claim 1,
wherein each of the plurality of sound wave generators measures a different area of the measurement object at different times, each scanning over the surface of the measurement object.

9. The characteristics measurement device according to claim 2,
wherein each of the plurality of sound wave generators generates sound waves once for each of the different points within the area of the measurement object with staggered timings and
wherein the control unit controls the timing of sound wave generation for each of the plurality of sound wave generators so that the sound waves generated at all generation timings reach the different points at the same time.

10. The characteristics measurement device according to claim 9,
wherein the sound waves generated by the plurality of sound wave generators are continuous pulses.

11. The measurement device according to claim 1,
wherein the sound wave source is a two-dimensional array probe in which the plurality of sound wave generators are arranged in a substantially plane array.

12. The measurement device according to claim 11,
wherein the two-dimensional array probe is an annular array probe in which a plurality of annular type elements are concentrically arranged and
wherein the control unit controls the timing of sound wave irradiation of each of the plurality of sound wave generators so that the sound waves generated by each of the annular elements reach different points in the measured object at the same time.

13. A measurement method for non-invasively measuring a measurement object, comprising:
generating sound waves using sound wave generating means to irradiate different points in a measurement object;
receiving an electromagnetic field generated at each point where the sound waves are irradiated; and
measuring a signal indicating at least one characteristic selected from the group comprising electrical characteristics, magnetic characteristics, electromechanical characteristics and magnetomechanical characteristics of the measurement object based on at least one selected from the group comprising the intensity, phase and frequency of the received electromagnetic field,
wherein sound waves generated by the sound wave generating means reach different points in the measurement object at the same time,
wherein the sound waves irradiated to each point in the measurement object are in phase and
wherein the sound waves are not focused on the measurement object.

14. The measurement method according to claim 13,
wherein the area of the measurement object is 4 mm to 10 mm.
